(19) United States
(12) Patent Application Publication
(10) Pub. No.: US 2004/0085935 A1
(43) Pub. Date: May 6, 2004

(54) Performance of a CDMA system

(76) Inventors: William N. Robinson, Grayslake, IL (US); Nicholas William Whinnett, Marlborough (GB)

Correspondence Address: MOTOROLA INC, 600 NORTH US HIGHWAY 45, ROOM AS437, LIBERTYVILLE, IL, 60048-5343, US

(21) Appl. No.: 10/289,072

(22) Filed: Nov. 6, 2002

(51) Int. Cl. H04B 7/216; H04J 3/16

(52) U.S. Cl. 370/335; 370/465

(57) ABSTRACT

A method for utilising resources of a CDMA telecommunications systems comprising a plurality of base stations and one or more mobile terminal is disclosed, which method comprises causing the base stations to indicate, to the one or more terminals, whether they have unused capacity and causing one or more of the mobile terminals to change or maintain constant its data rate dependent upon the unused capacity indication received from the base stations. A contention resolution phase may be used so that only sufficient terminals increase their data rate to accommodate the unused capacity.

### BACKGROUND OF THE INVENTION

This invention relates to improving the performance of a Code Division Multiple Access (CDMA) system, and preferably to one including mixed voice and data services.

CDMA systems are well known and examples of such systems which are known or proposed include UMTS, cdmaOne, W-CDMA, Multi-Point CDMA WiLL Technologies, and any other DS-CDMA (Direct Sequence-CDMA) systems. The present invention is also applicable to frequency-hopping CDMA systems.

CDMA systems are now well established but efforts to improve such systems have frequently focused on the delivery of speech and other circuit switch services using power control and soft hand-off techniques amongst others. There is still a need for simple and well optimised methods for the delivery of bursty data services which can tolerate delay variation in a DS-CDMA system. Examples of such services are e-mail, file transfer, still image delivery, non real-time speech, non real-time video images and the like. All of these services will be offered by third generation systems such as UMTS and can be supported by packet data transmission mechanisms which can be bursty and tolerate delay variation.

There remains a significant need to provide an efficient method for optimising the uplink throughput and capacity of DS-CDMA systems with mixed voice and data traffic.

A typical cellular telephone system is shown in FIG. 1. The system comprises a plurality of base stations B₁ to Bₙ and a second plurality of mobile terminals MT₁ to MTₙ (e.g. mobile telephones or radios) using the cellular system.

Only a small number of cells and mobile stations are shown in FIG. 1 but in practice of course a large number of both will generally be present.

Each of the base stations is receiving and decoding transmissions from several mobile terminals MT at a given frequency bandwidth. This is shown schematically in FIG. 2. Also, as shown in FIG. 1, the signal transmitted from each mobile terminal, such as MT₁, will usually be received by a plurality of base stations. In this case, the signal from mobile terminal MT₁ is being received by base stations B₁, B₂, B₃ and B₄ although, as it is at different distances from these, the signal strength received by each base station will differ. Similar, the mobile terminal MT₁ could receive transmissions from each of these base stations.

Any given base station is receiving and decoding transmissions from a number of mobile terminals. However, any particular base station only has a certain uplink capacity. This may be seen as the maximum useful received power which the base station can handle whilst still maintaining a satisfactory level of interference from other transmitters. The amount of useful received power received by the base station at any time is clearly dependent upon the number of mobile terminals with which it is communicating and the signal power received from each one (a terminal can vary its transmitting power). Referring to FIG. 3, there is shown a plot of power received by the base station against time. At a first time, only a first mobile terminal MTₐ is communicating and therefore the base station received an average power of Pₐ. Time T₁ later, a second terminal begins communicating, in addition to the first terminal, at a power P₂. The power received by the base station therefore becomes, on average, P₁+P₂. Subsequently a third station MT_{c} is added at a power of P₃ and the power received goes up to P₁+P₂+P₃ and so on. The transmissions from each terminal may be seen as a source of interference for the received signal of the other terminals as detected at the base station.

The base station may have a maximum capacity P_{MAX} which now begins to be approached.

At any time, a given base station is receiving and decoding transmissions from a number of mobile terminals as described. However, the uplink capacity of that base station may not yet be saturated. In this case, it will be desirable to utilise this unused uplink capacity whenever it is available by, for example, increasing the data rate of one or more of the mobile terminals which is transmitting packet data. Thus, in the example of FIG. 3, the maximum capacity of the base station has not yet been reached. It is most efficient for the base station to be fully utilised and therefore any of terminals MTₐ to MT_{d} could increase their power output, which would increase the total power received and cause it to approach P_{MAX}.

However, simply instructing one or more of the mobile terminals to increase its data rate causes more energy to be emitted by that particular mobile terminal. As seen in FIG. 1, the signal from terminal MT₁ is received not only by base station B₁ but also by stations B₂, B₃ and B₄. Thus, if terminal MT₁ increases its data rate it causes more energy to be emitted by that mobile terminal which will cause additional interference into adjacent cells. If any one of these adjacent cells is already operating at its maximum uplink capacity, then this additional interference will cause all the other transmissions into the base station of that adjacent cell to be blocked by excessive interference. Thus, increasing the capacity utilisation in a first cell can have an undesirable effect on a previously fully loaded adjacent cell.

The present invention arose in an attempt to avoid this situation.

### BRIEF SUMMARY OF THE INVENTION

According to the present invention in a first aspect there is provided a method for utilising resources of a CDMA telecommunications system comprising a plurality of base stations and one or more mobile terminals, which method comprises causing the base stations to provide, to the one or more terminals whether they have unused capacity and causing one or more of the mobile terminal to change or maintain constant its data rate or power output depending upon the unused capacity messages received from the base stations.

According to the present invention there is further provided a CDMA telecommunications network comprising a first plurality of base stations and one or more mobile terminals, wherein each base station is adapted to indicate to the or each mobile terminal with which it is in communication, any unused capacity, and wherein the mobile terminals are adapted to change or maintain their data rate or power output dependent upon the unused capacity indication received from the base stations.

In a further aspect, the invention provides a base station for a mobile telecommunications network, including means for indicating any unused uplink capacity to mobile terminals with which it is in radio communication.

In a further aspect, the invention provides a mobile terminal, for a CDMA telecommunications system, and having a variable data rate, comprising means for receiving indications of unused uplink capacity from any base stations with which it is in communication, and means for maintaining or changing the data rate or power output of the terminal in accordance with the unused capacity indications received from the base stations.

### BRIEF DESCRIPTION OF THE DRAWINGS

Embodiments of the invention will now be described, by way of example only, with reference to the accompanying drawings in which:

FIG. 1 shows schematically a cellular network;

FIG. 2 shows a plurality of mobile terminals sending and receiving information to and from a base station;

FIG. 3 shows schematically the power load on a base station;

FIG. 4 shows schematically an alternative power load on a base station; and

FIG. 5 shows schematically a base station and a mobile terminal.

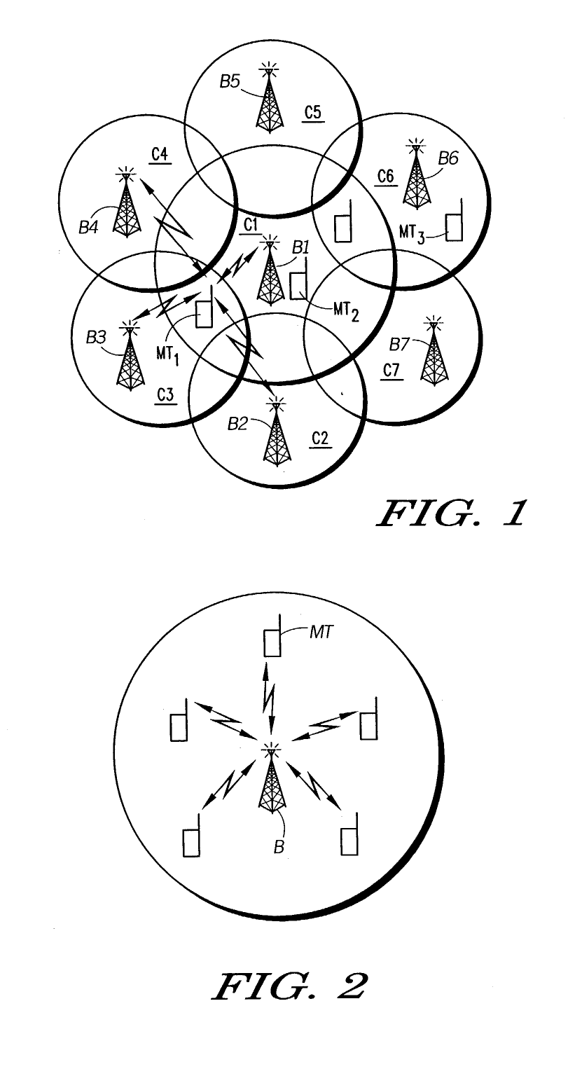

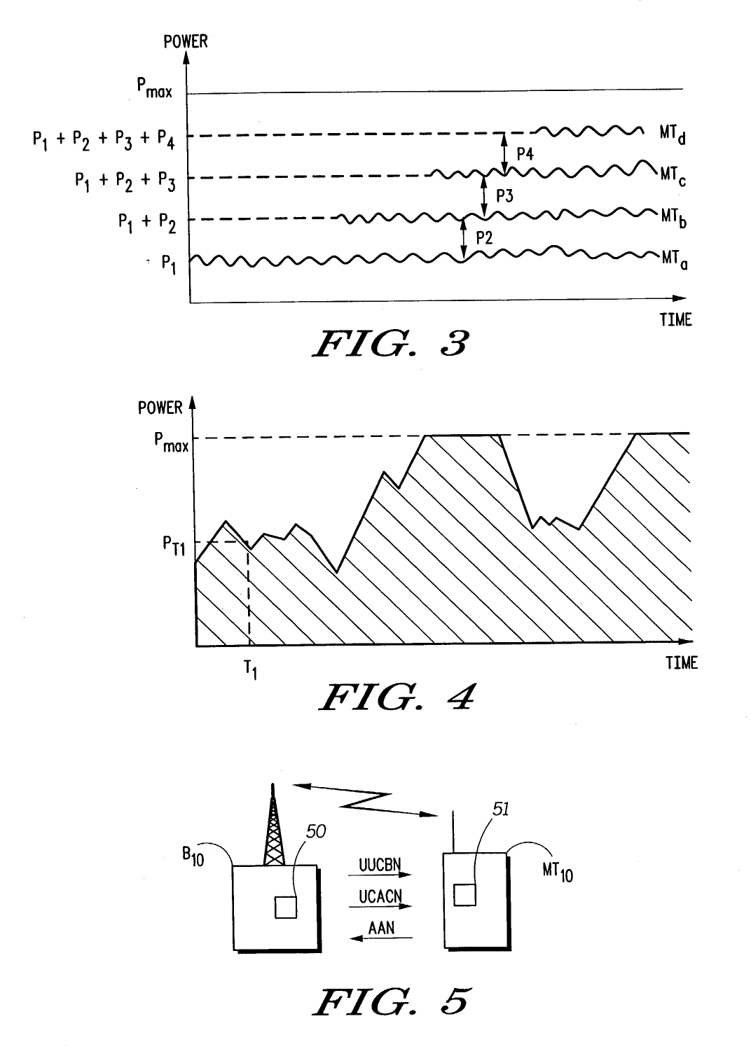

### DETAILED DESCRIPTION OF PREFERRED EMBODIMENTS OF THE INVENTION

Referring again to the situation of FIG. 1, each of the base stations B₁ to B₇ has a particular capacity. In embodiments of the invention, each of the base stations is arranged to broadcast a number or value which may be called the unused uplink capacity broadcast number (WUCBN). This indicates the amount of unused uplink capacity available at that time at that base station. Thus, referring to FIG. 4, at time T₁ the amount of power being used by the base station is P_{T1}. Thus, the unused capacity at time T₁ is fn(P_{MAX}−PT₁). The base station can therefore indicate, in its UUCBN, the amount of unused uplink capacity fn(P_{MAX}−PT₁) which is available. The amount of indication of unused capacity in this broadcast may be artificially reduced if, for example, there is a fully loaded base station nearby, such as B6, which may not be being decoded by the one or more mobiles in the vicinity, but where interference may still occur.

Each mobile terminal which is transmitting packet data decodes the UUCBN broadcast from each of the base stations to which the mobile is connected. This need not require any additional hardware at the mobile terminal, simply a small modification to the software so that amongst the many different types of data which the terminal receives from the base station, the UUCBN data can also be decoded.

Each mobile terminal can, of course, receive signals from several base stations, as is shown from FIG. 1. The mobile terminal which is in a position to transmit packet data or other data which is tolerant of delay variations, therefore continuously determines which of the following three states apply:

State 1: all of the UUCBN broadcasts indicate that unused uplink capacity is available on the respective base stations.

State 2: one or more of the UUCBN broadcasts indicate that the uplink capacity at the respective base station is fully utilised (i.e. maximum value for self plus inter-cell interference).

State 3: one or more of the UUCBN broadcasts indicates that the uplink capacity at the respective base station is being adversely affected by excessive interference.

If state 2 or state 3 exists, then clearly the mobile terminal cannot increase its data rate or otherwise increase the power it transmits, since this would then adversely affect or overload one or more of the base stations.

If state 1 exists, then at least one mobile terminal could increase its data rate. However, it should be remembered that there may be multiple mobile terminals transmitting packet data, and which all may have simultaneously detected that state 1 exists for the respective terminal. Thus, in FIG. 1, if base station B, has unused uplink capacity, this would be noted by both mobile terminals MT₁ and MT₂. However, if both those terminals attempt to increase their data rate, then the uplink capacity may become overloaded. The number of mobile terminals which have detected that state 1 exists is not known to the terminals themselves.

Accordingly, in some embodiments of the invention, in order that the unused uplink capacity is not wasted a form of uplink bandwidth contention resolution is required so that at least one terminal can exploit the unused uplink capacity. That is, some form of competition between terminals is necessary in order that only some of them can increase their data rate or power output so as to take advantage of the uplink capacity of the base station.

A preferred method of resolving this dilemma is as follows:

Each base station with unused uplink capacity will at any time have knowledge of how many terminals which are transmitting packet data (Mp) are being received at that base station. The base station transmits that number of terminals as a number, known as the Unused Capacity Access Control Number (UCACN). The UCACN is directly derived from that number of terminals using an a priori defined algorithm. This may be any of a number of suitable algorithms but example algorithms for the generation of the UCACN may be as follows:

UCACN=K×1/Mp (1)

or

UCACN=K×100/Mp (2)

or

UCACN=K×(a/Mp+b/Mp+c/Mp+ . . . ) (3)

where

K is a factor for which a value is selected to balance the probability of an excessive number of terminals accessing the unused uplink capacity with the probability that no terminals access the unused uplink capacity, and

the series a, b, c represent subscription priority weighting factors. These may be used if, for example, users may be able to pay a premium in their subscription which entitles them to priority access. In embodiments of the invention, the payment of such a premium does not guarantee priority access but gives a higher probability that priority access will be given to that terminal.

Clearly, many other algorithms may instead be employed.

Each of the Mp terminals determines whether it is capable of increasing its uplink data transmission rate within the available capacity which has been indicated by the set of received UUCBNs. If this is the case, the terminal randomly generates an Access Attempt Number (AAN) which preferably has a probability of 1/UCACN of meeting some selection criteria (e.g. less than some threshold value). An alternative relationship between the AAN and UCACN may also be used without deviating from the main purpose of this invention. If the particular criterion is met, then the mobile terminal indicates to the or each base station which has unused capacity, that it will increase its data rate and proceeds to increase its data rate. This is typically done by one pre-determined data rate step, e.g. doubling its data rate.

There may be circumstances arising from the above algorithm, in which too many terminals indicate that they wish to increase their data rates. This can instigate a further contention resolution phase in which the base station randomly selects from the terminals wishing to increase their data rate and signals to only those selected terminals that have (or have not) been granted access to the unused uplink capacity.

If the DS-CDMA (Direct Sequence-CDMA) system employs spreading factors with a factor 2 geometric relationship, such as 4, 8, 16, 32, etc, then the algorithm for generating the AAN may include a factor giving lower rate users a better chance of fulfilling the selection criterion. This is because a user who is currently sending data at a lower bit rate is able to increase the power level by a small amount and therefore more of these users may be able to increase their rate, whereas a higher rate user, by doubling his rate, may too quickly cause the uplink capacity to be exceeded. In one example,

AAN=Random Number/Existing Data Rate (4)

Thus, the smaller the data rate, the higher the probability of success. Note that the value of AAN may also be influenced by the number of base stations with which the terminal is in soft handoff.

If the subscription arrangements for a given user allow for higher or lower priority access to the unused uplink capacity, then the algorithm in the terminal for generating the AAN can be suitably adjusted to take this into account. For example:

AAN=Random Number×Priority Waiting (5)

If the explanations behind the derivation of equations (4) and (5) both apply, then the AAN may be based on the following algorithm:

AAN=Random Number×Priority Waiting/Existing Data Rate (6)

if

AAN>threshold value

then

increase data rate

else

no change

endif

If state 2 exists, then the mobile terminal takes no new action and continues to transmit data at the previous data rate.

If state 3 exists, then the mobile terminal indicates to the affected base station that it is about to reduce its data rate and proceeds to reduce its data rate by a pre-determined rate step. This reduction in data rate can be achieved by either terminating one of the spreading codes being used by the mobile (in the case of multiple codes being employed) or by increasing the spreading rate but keeping the absolute chipping rate the same.

It may not be necessary for all mobile terminals to reduce their power. If this is the case, then a subset of the mobile terminals connected to the base station can “choose themselves at random” to reduce their powers, using mechanisms equivalent to those described for state 1 above. Most preferably, this includes the options to ensure that mobile terminals which are consuming more capacity, or terminals having a lower priority, tend to reduce their power first.

Furthermore, mobile terminals in state 3 which are in soft handoff, but who are not actually being power controlled by the base station indicating excessive interference, may be preferentially permitted to keep their present data rates, since their interference contribution will be less. This is because the received power from these mobile terminals will be less than for those mobile terminals who are being power controlled by the base station. One non-limiting example of a threshold detection algorithm could be:

DRRN=Random Number×Priority Waiting×PC-fac/Existing Data Rate (7)

where

DRRN is “Data Rate Reduction Number”

PC-fac=1.0 if the mobile last received a “power down” power control command from the interfered with base station, and PC-fac=1.5 otherwise.

if

DRRN<threshold value

then

reduce data rate

else

no change

endif

FIG. 5 shows a base station B₁₀ and a mobile terminal MT₁₀. Each has a respective processing means 50, 51 used for generating the respective values of the present invention, such as the UUCBN, UCACN and AAN. The processing means will generally be the existing processors which the respective stations already have, and software may be used in embodiments of the invention to generate the various values, etc.

1. A method for utilising resources of a CDMA telecommunications systems comprising a plurality of base stations and one or more mobile terminals, which method comprises causing the base stations to provide an indication, to the one or more terminals, of unused capacity (UUCBN) and causing one or more of the mobile terminals to change or maintain constant its data rate or power output dependent upon the unused capacity indication received from the base stations.

2. A method as claimed in claim 1, including the step of causing a mobile terminal to increase its data rate only if all base stations, with which that mobile is in communication, indicate that they have unused capacity.

3. A method as claimed in claim 2, including a contention resolution step such that only a portion of the mobile terminals which are in communication with a group of base stations which all indicate that they have unused capacity, are caused to increase their data rate.

4. A method as claimed in claim 3, wherein each base station with unused capacity is arranged to transmit a first value related to the number of mobile terminals which are in data communication with that terminal and each mobile terminal is arranged to randomly generate a second value which has a probability, related to said value, of meeting a selection criterion, and, wherein only those terminals whose generated second value meets the criterion are enabled to increase their data rate.

5. A method as claimed in claim 4, wherein the first value is derived from the number of terminals using a factor for which a value is selected to balance the probability of an excessive number of terminals accessing the unused capacity with the probability that no terminals access the unused capacity.

6. A method as claimed in claim 5, wherein the first value (UCACN)=K×X/Mp where K is selected to balance the probability of an excessive number of terminals accessing the unused capacity with the probability that no terminals access the unused capacity, X is a number and Mp is the number of mobile terminals in data communication with the base station.

7. A method as claimed in claim 6, wherein the first value (UCACN)=K×(a/Mp+b/Mp+c/Mp . . . ) where K is selected to balance the probability of an excessive number of terminals accessing the unused capacity with the probability that no terminals access the unused capacity, and the series a, b, c . . . represent subscription priority weighing factors.

8. A method as claimed in any of claims 4 to 7, wherein the second value (AAN), generated by each mobile terminal, has a probability 1/UCAN of meeting said selection criteria, where UCACN is the first value generated by the base station.

9. A method as claimed in claim 8, wherein the second value (AAN) is generated by an algorithm which gives a better chance of fulfilling the selection criteria to lower data rate users.

10. A method as claimed in claim 8 or claim 9, wherein the second value (AAN) generated by a mobile terminal is related to the number of base stations with which the mobile terminal is in soft handoff.

11. A method as claimed in any of claims 8 to 10, wherein the second value (AAN) is related to a level of priority access accorded to a user of the mobile terminal.

12. A method as claimed in any of claims 4 to 11, wherein, if too many mobile terminals are successful in the contention resolution step, a further step is implemented in which the base station randomly selects one or more terminals.

13. A method as claimed in claim 1, including the step of causing one or more mobile terminals to reduce their data rate if a base station indicates that its uplink capacity is being affected by excessive interference.

14. A method as claimed in claim 13, including a contention resolution step for selecting which of the mobile terminals affecting the base station reduce their data rate.

15. A method as claimed in claim 14, wherein mobile terminals which are in soft handoff and are not being power controlled by the base station indicating excessive interference, are preferentially permitted to maintain their existing data rate.

16. A method as claimed in any preceding claim, wherein the unused capacity indication of a base station is reduced if an adjacent or nearby base station is high- or fully-loaded.

17. A CDMA telecommunications network comprising a first plurality of base stations and one or more mobile terminals, wherein each base station is adapted to indicate to the or each mobile terminal with which it is in communication, any unused capacity, and wherein the mobile terminals are adapted to change or maintain their data rate or power output dependent upon the unused capacity indication received from the base stations.

18. A telecommunications network as claimed in claim 17, including contention resolution means.

19. A base station for a mobile telecommunications network, including means for indicating any unused uplink capacity to mobile terminals with which it is in radio communication.

20. A base station as claimed in claim 19, further including means for generating and transmitting a value related to the number of mobile terminals which are in data communication with the base station.

21. A base stationed as claimed in claim 19 or claim 20, wherein the indication of unused uplink capacity is dependent upon knowledge of adjacent base station capacities.

22. A mobile terminal, for a CDMA telecommunications system, and having a variable data rate, comprising means for receiving indications of unused uplink capacity from any base stations with which it is in communication, and means for maintaining or changing the data rate or power output of the terminal in accordance with the unused capacity indications received from the base stations.

23. A mobile terminal as claimed in claim 22 which is adapted to change its data rate only if all base stations indicate that they have unused capacity.

24. A mobile terminal as claimed in claim 23 which includes contention resolution means.

25. A method for utilising resources of a CDMA system substantially as hereinbefore described with reference to and as illustrated by the accompanying drawings.

26. A contention resolution method substantially as hereinbefore described with reference to and as illustrated by the accompanying drawings.

27. A CDMA telecommunications system substantially as hereinbefore described with reference to and as illustrated by the accompanying drawings.

28. A base station substantially as hereinbefore described with reference to and as illustrated by the accompanying drawings.

29. A mobile terminal substantially as hereinbefore described with reference to and as illustrated by the accompanying drawings.
